(19) United States
(12) Patent Application Publication
(10) Pub. No.: US 2016/0061355 A1
(43) Pub. Date: Mar. 3, 2016

(54) Wire Retaining Apparatus and Method

(71) Applicants: Adam C. Sherman, Newark, CA (US); Brian S. Park, Dublin, CA (US)

(72) Inventors: Adam C. Sherman, Newark, CA (US); Brian S. Park, Dublin, CA (US)

(21) Appl. No.: 14/476,562

(22) Filed: Sep. 3, 2014

(51) Int. Cl. F16L 3/223; F16L 3/06

(52) U.S. Cl. CPC F16L 3/2235; F16L 3/06

(57) ABSTRACT

Embodiments provide a wire retaining apparatus including a base and a plurality of retention members. The base has a first end and a second end opposite the first end, and an upper side and a lower side. The plurality of retention members extend away from the upper side of the base. Each retention member includes a wall portion and a flange portion that protrudes from an upper peripheral portion of the wall portion. The flange portion is angled upwardly away from the upper side of the base forming a retention gap to receive one or more wires of different diameter.

### BACKGROUND

Under floor heating systems are known in the art. In such applications, one or more heating wires are disposed between a subfloor surface and a main floor surface. Once activated, the heating wires transmit heat to the main floor surface, which may then be heated to a desired temperature. Floor heating systems may be particularly useful in cold weather climates. In other applications, heating wires may be disposed on or adjacent to a different surface to provide heat thereto. For example, a heating wire may be utilized on a roof surface to provide a snow melting and an ice dam prevention mechanism. Other applications may include heating wires within or adjacent to walkways, entryways, or gutter downspouts to provide de-icing capabilities.

To provide an effective and consistent heating area, the heating wires are arranged in a particular pattern to provide an efficient and uniform heating mechanism. To that end, one or more wire retaining apparatuses may be utilized to hold the heating wires in the desired orientation and spacing for uniform power output within a given area. In some instances, the wire retaining apparatus is provided in the form of a plurality of strips that may be coupled together and attached to the subfloor (or other surface). Once attached, the heating wires may be coupled to the wire retaining apparatus to maintain the heating wires in the desired orientation. After installation of the heating wires, the main floor (or other) surface may be installed on top of the heating wires such that the wire is positioned adjacent and/or is in contact with an underside of the main floor.

One wire retaining apparatus includes a support structure having a plurality of protrusions that extend from a surface. Pathways are formed between the protrusions that are adapted to receive a flexible heating wire. The support structure supports a main floor and is supported by a sub-floor. The support structure is constructed of a flexible material designed to accommodate shifting of the sub-floor to provide a flat and level main floor surface.

Another wire retaining apparatus includes a heating cable guide strip having curved sections for guiding the heating cable along a curved path. The curved sections include a top horizontal flexible flange that projects outwardly. The heating cable guide strip includes wave-shaped formations that provide alignment of guide strips to be lined up without interlocking or forming a secure connection.

Unfortunately, known wire retaining apparatuses have numerous drawbacks. For example, it may be difficult to secure heating wires of different sizes to the same wire retaining apparatus. As such, numerous different-sized wire retaining apparatuses may need to be utilized in a single installation to accommodate the difference in diameter, resulting in increased expense and effort during the installation process.

Another drawback is that wires of different sizes may not be attached to the wire retaining apparatus in a secure manner. In particular, the wire retaining apparatus may have one or more retaining elements that are shaped to accommodate a specifically dimensioned wire. In instances where a differently dimensioned (e.g., smaller or larger diameter) wire may be used, the retaining element may not grip or otherwise interact with the wire in a manner to secure the wire thereto. When smaller diameter wires are used, extra care and effort is necessary to keep the wire properly tensioned so as to prevent the wire from lifting away through curling. In other instances, the retaining elements may not be flexible enough to accommodate a wire with a larger diameter.

A further drawback to known wire retaining apparatuses is the mechanism by which the plurality of strips are coupled together. For example, some strips simply include a protrusion designed to loosely interact with an opening disposed in a different strip. In many instances, this interaction is not secure and may result in the strips becoming uncoupled from each other.

In light of the above issues, a need exists for a way in which to couple a plurality of strips together in a secure manner. A further need exists for a wire retaining apparatus designed to securely retain wires of different diameters.

### SUMMARY

Some embodiments provide a wire retaining apparatus including a base and a plurality of retention members. The base includes a first end and a second end opposite the first end, and an upper and a lower side. The plurality of retention members protrude outwardly from the upper side of the base. Each retention member includes a wall portion and a flange portion that circumscribes and extends outwardly from an upper peripheral portion of the wall portion. The flange portion is angled upwardly away from the upper side of the base and forms a retention gap configured to receive a wire.

Some embodiments provide a method of forming a wire retaining system. The method includes the step of providing a first and a second wire retaining apparatus, each including a plurality of retention members. The plurality of retention members of the first and second wire retaining apparatus each define a plurality of retention gaps for receiving one or more wires having a different diameter with respect to each other. The first wire retaining apparatus further includes a first portion of a coupling mechanism provided in the form of a lower protrusion and at least one coupling aperture. The second wire retaining apparatus further includes a second portion of a coupling mechanism provided in the form of at least one coupling post and an opening. The first and second wire retaining apparatuses are coupled together by pressing the at least one coupling post into the at least one coupling aperture, whereby the lower protrusion is retained within the opening in a coupled configuration.

Some embodiments provide a wire retaining apparatus including a base having a first end and a second end opposite the first end, and further including an upper side and a lower side. A plurality of retention members extend from the base. Each retention member includes a wall portion and a flange portion that protrudes from an upper peripheral portion of the wall portion. The flange portion of each of the plurality of retention members form wire insertion gaps. The wire insertion gaps have a continuously variable gap length that has a minimum value at a central point.

### DESCRIPTION OF THE DRAWINGS

FIG. 1 is an isometric view of a wire retaining apparatus having a base and a plurality of retention members according to one embodiment;

FIG. 2 is a side view of the wire retaining apparatus of FIG. 1;

FIG. 3 is a top view of the wire retaining apparatus of FIG. 1;

FIG. 4 is a bottom view of the wire retaining apparatus of FIG. 1;

FIG. 5 is an enlarged top view of a portion of the wire retaining apparatus of FIG. 3;

FIG. 6 is an enlarged side view of a portion of the wire retaining apparatus of FIG. 2;

FIG. 7 is an enlarged isometric view of an end of the wire retaining apparatus of FIG. 1;

FIG. 8 is an enlarged bottom isometric view of the end of the wire retaining apparatus of FIG. 7;

FIG. 9 is an enlarged isometric view of an opposing end of the wire retaining apparatus of FIG. 1;

FIG. 10 is an enlarged rear view of the wire retaining apparatus of FIG. 1;

FIG. 11 is an enlarged front view of the wire retaining apparatus of FIG. 1;

FIG. 12 is an exploded view depicting the assembly of one end of a first wire retaining apparatus onto the opposing end of a second wire retaining apparatus; and

FIG. 13 is a schematic view of a wire retaining system using a plurality of wire retaining apparatuses coupled together.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Embodiments of the present disclosure provide a system and a method for installing and maintaining one or more heating wires in a pre-defined orientation using a plurality of wire retaining apparatuses that are designed to be securely coupled together. The wire retaining apparatuses can be used in a number of applications including residential and commercial flooring, roofing, walls, siding, and the like. Each application may include two substantially parallel surfaces defining a gap therebetween. The gap is sized to hold the heating wire such that the heating wire is in communication with one or both of the surfaces.

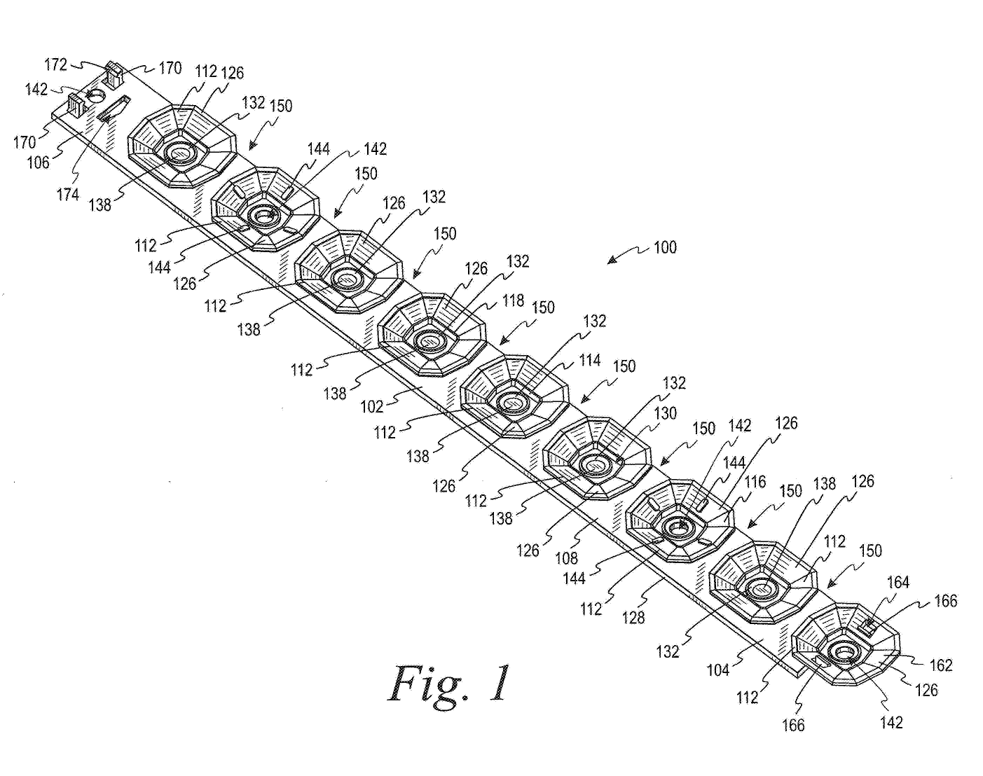

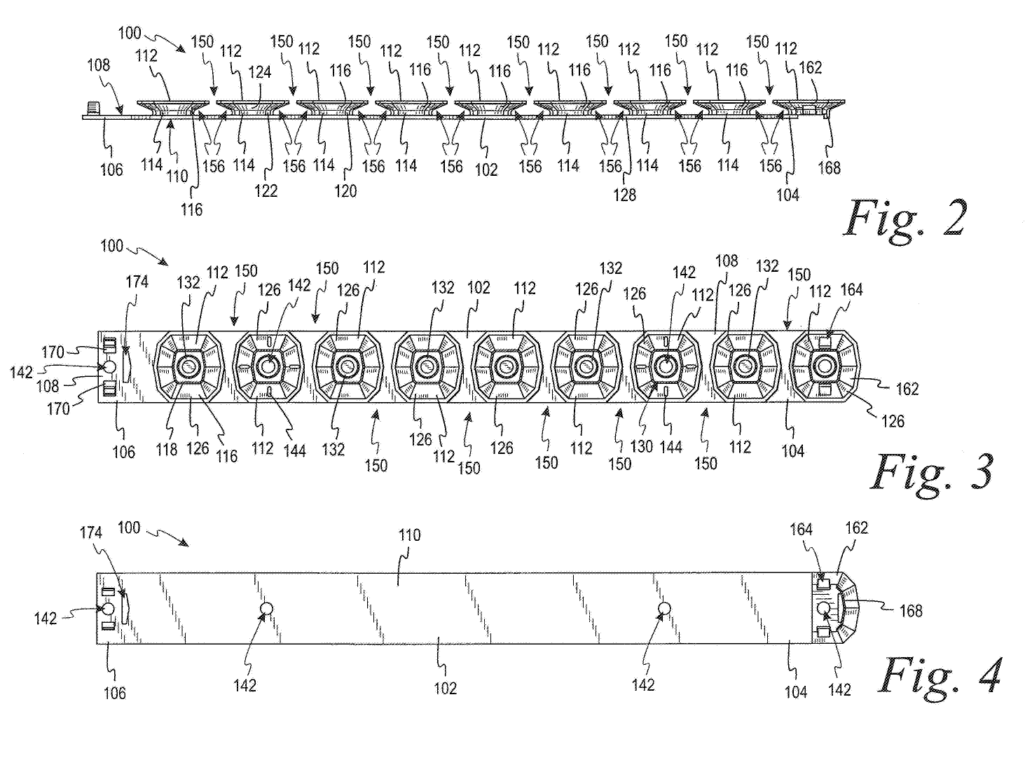

FIGS. 1-4 illustrate a wire retaining apparatus 100 according to one embodiment. The wire retaining apparatus 100 includes an elongate base 102 and a plurality of retention members 112 extending from the base 102. The base 102 is defined by a thin strip having a first end 104, an opposing second end 106, an upper face 108, and a lower face 110. The plurality of retention members 112 are disposed on and extend away from the upper face 108 of the base 102. In the embodiment depicted, nine retention members 112 extend from the base 102. In other embodiments, it is envisioned that more or less retention members 112 may be included as appropriate for the specific application.

Referring to FIGS. 1-8, each of the plurality of retention members 112 includes a wall portion 114 and an integral flange portion 116. The wall portion 114 is generally decagonal in shape and includes a generally vertical inner surface 120 and a faceted outer surface 122. The generally vertical inner surface 120 of the wall portion 114 further defines an interior volume 130.

Attachment guides 132 are centrally disposed within an orifice defining the interior volume 130 of each of the retention members 112. The attachment guides 132 extend outwardly from the upper face 108 of the base 102 and are each defined by a slightly raised cylindrical outer wall 134 and a sloped surface 136 that terminates at a substantially flat interior surface 138. The thickness of the base 102 may be reduced in an area adjacent the interior surface 138 in some embodiments. It is also contemplated that one or more of the attachment guides 132 may include an inner cylindrical wall 140 that defines a through hole 142 (see e.g., FIG. 8). In some embodiments, the interior surface 138 may include a small through hole (not shown) adapted to receive a tip of a nail or a screw (not shown). One or more of the attachment guides 132 may include a through hole 142 that extends entirely through the base 102 and/or a portion of the way through the base 102. In some embodiments, the attachment guides 132 may not include any through holes 142 extending entirely through the base 102.

As shown in the embodiment depicted in FIGS. 1 and 3, some of the retention members 112 include attachment guides 132 having through holes 142 and/or some of the retention members 112 include attachment guides 132 having a reduced thickness in an area adjacent the interior surface 138 at the base 102. It is contemplated that the through holes 142 may be located within different retention members 112 in some embodiments. The spacing of the through holes 142 may be a visual indicator to an installer of suggested spacing for attachment mechanisms. The reduced thickness of the base 102 at the interior surface 138 allows the installer to employ attachment mechanisms in any location that is favorable for the specific installation with less effort than driving attachment mechanisms through the full thickness of the base 102.

Certain embodiments may also include one or more types of attachment mechanisms (not shown) designed to be used in conjunction with the attachment guides 132 to secure the wire retaining apparatus 100 to a surface (not shown). Some non-limiting examples of attachment mechanisms may include screws, nails, rivets, and staples. In the present embodiment, the attachment guides 132 are configured to support a head of a screw or nail (not shown). One advantage of the present configuration is that the support provided by the attachment guides 132 prevents and/or reduces damage from over driving a screw or nail into the apparatus 100, which results in an easier and more efficient installation.

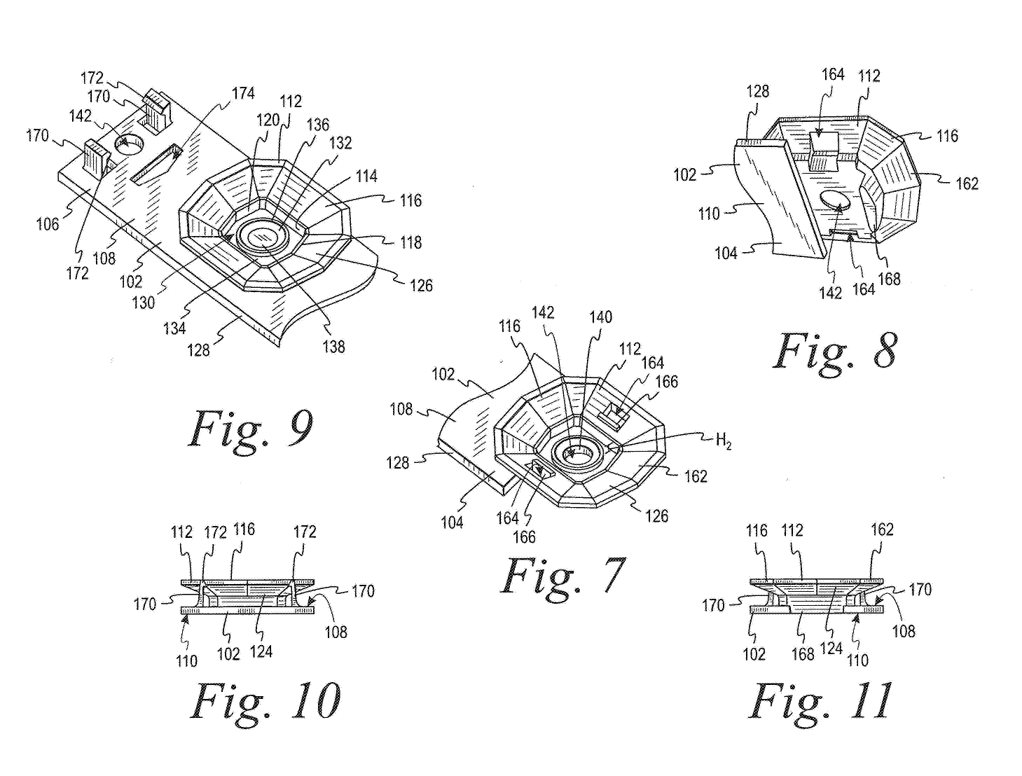

Still referring to FIGS. 1-8, the flange portion 116 protrudes from and circumscribes an upper peripheral portion 118 (see FIG. 9) of the wall portion 114. The flange portion 116 is also generally decagonal in shape and includes a lower surface 124 that is angled upwardly and terminates at a substantially flat upper surface 126. The entirety of the flange portion 116 of each of the plurality of retention members 112 is generally angled away from the upper face 108 of the base 102. In the embodiment depicted in FIGS. 1-12, an angle A (see FIG. 6) is formed between the lower surface 124 of the flange portion 116 and the upper face 108 of the base 102 and is about 22 degrees. In other embodiments, the angle A may be between about 15 degrees and about 35 degrees. In a further embodiment, the angle A may be between about 10 degrees and about 50 degrees. For reasons discussed below, the angle A may be larger or small in certain embodiments.

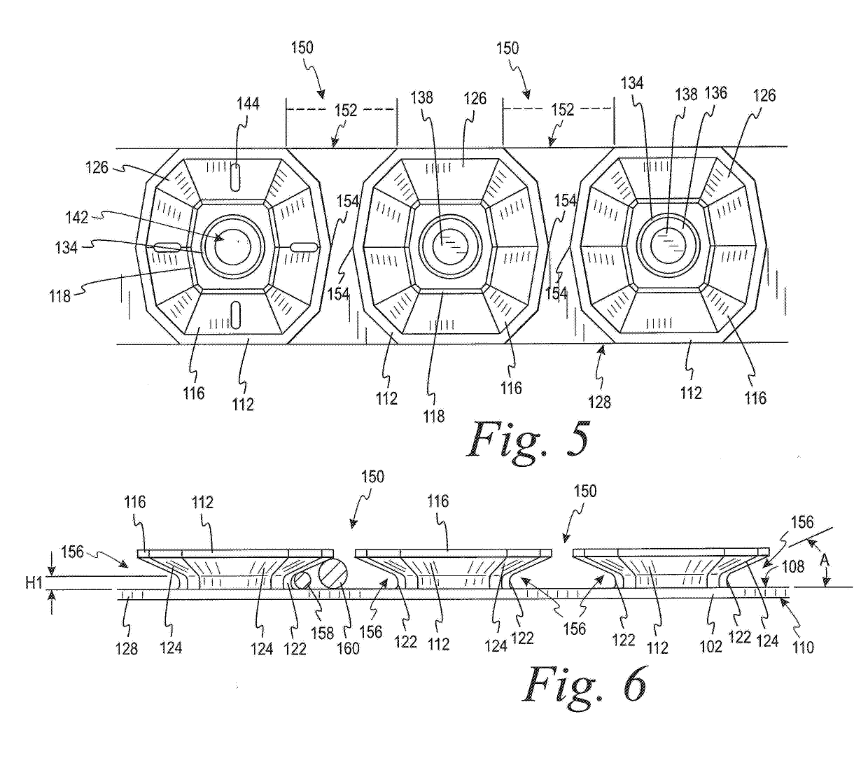

In some embodiments, one or more indicators 144 (see FIGS. 1 and 5) may be disposed on and extend from the upper surface 126 of the flange portion 116. The indicators 144 can be a visual and/or a tactile marker to an installer that the through hole 142 is disposed within a specific attachment guide 132. It is contemplated that one or more of the indicators could be a raised feature and/or comprise a contrast of color, material, or texture with respect to the material of the flange portion 116. In one embodiment, there are four indicators 144 disposed equidistantly around the upper surface 126 of the flange portion 116.

In the embodiment shown in FIGS. 1-12, the faceted outer surface 122 of the wall portion 114 is defined by a height dimension H₁ (see FIG. 6) of about 1.5 millimeters. It is also contemplated that in some embodiments, the inner surface 120 of the wall portion 114 may be defined by a height dimension H₂ (see FIG. 7) greater than about 2 millimeters. Thus, the volume 130 defined by the inner surface 120 may represent a depression into the base 102. It is also contemplated that in some embodiments the inner surface 120 of wall portion 114 may be the same height as the faceted outer surface 122 or may be less. In other embodiments, the thickness of the base 102 may be about 1.6 millimeters.

Turning to FIG. 5, the flange portions 116 of each of the plurality of retention members 112 define a wire insertion gap 150 between adjacent flange portions 116. The shape of the flange portions 116 favorably allow the insertion gap 150 to have wider openings 152 in proximity to the side edges 128 of the base 102 (as best seen in FIG. 5). Additionally, the distance between the flange portions 116 is minimized at a central point 154. The variation in the distance between the flange portions 116 enables an installer to easily insert a wire (not shown) that is larger than the minimum insertion gap 150 width at the openings 152. Further, minimizing the insertion gap 150 at point 154 enables smaller wires to still be retained by the wire retaining apparatus 100.

In the embodiments shown in FIGS. 1-12, the minimum width dimension of the insertion gap 150 at the point 154 is about 2.5 millimeters. The maximum width dimension of the insertion gap 150 at the openings 152 is about 15 millimeters. The amount of insertion force required to press a wire through the gap 150 may be influenced and controlled by the shape and thickness of the flange portions 116 of the retention members 112 and the size and shape of the insertion gap 150.

It is also contemplated that the insertion gap 150 may vary in size and shape between retention members 112 on a single wire retaining apparatus 100. For example, some of the retention members may be configured to form gaps 150 adapted to retain wires that are wide and flat while other retention members 112 on the same wire retaining apparatus 100 may be configured with different shaped and sized features to retain both large and small wires. Thus, a wire retaining apparatus 100 with a configuration as just described may be utilized in different applications (e.g., the retention of communication cables).

Now turning to FIG. 6, wire retention pockets 156 are defined by the upper face 108 of the base 102, the faceted outer surface 122 of the wall portion 114, and the lower surface 124 of the flange portion 116 of the retention member 112. The wire retention pockets 156 are configured to have a design amenable to securing differently shaped and sized wires. For example, a wire 158 having a small diameter (e.g., about 2.8 millimeters) is depicted inserted into the one of the wire retention pockets 156 in FIG. 6. Additionally, a wire 160 having a larger diameter (e.g., about 3.5 millimeters) is also depicted inserted into one of the wire retention pockets 156.

In some embodiments, the range of wire diameters that may be retained by the interaction of the wire and the wire retention pocket 156 may be from about 2.1 millimeters to about 4.2 millimeters. It is contemplated that by adjusting the dimension H₁ and the angle A, the range of wires that may be retained can be increased or decreased as required. Further, a wire having a diameter smaller than the minimum diameter (e. g., about 1 millimeter) than the range for the retention pocket 156 may still be retained within the retention pocket with proper tensioning by the installer. Additionally, the present embodiment may accommodate wires oversized (not shown) for the retention pockets 156. Larger, oversized wires may require extra insertion force by the installer. The maximum wire size that the wire apparatus 100 may retain can be modified by adjusting the insertion gap 150, the dimension H₁, and the angle A.

Wires 158, 160 of different diameters may be securely retained in the wire retention pocket 156 by contacting both the upper face 108 of the base 102 and lower surface 124 of the flange portion 116. It is contemplated that the faceted outer surface 122 of the wall portion 114 may be configured to grip a minimum diameter wire in some embodiments. Further, the shape of the wire retention pockets 156 may be configured to advantageously retain different sizes and shapes of wires for different applications. It is contemplated that the angle A, the spacing of the retention members 112, the shape and size of the faceted outer surface 122 of the wall portion 114, and the shape of the lower surface 124 may be adjusted individually or together to configure the retention capabilities of the wire retaining apparatus 100 for a variety of applications.

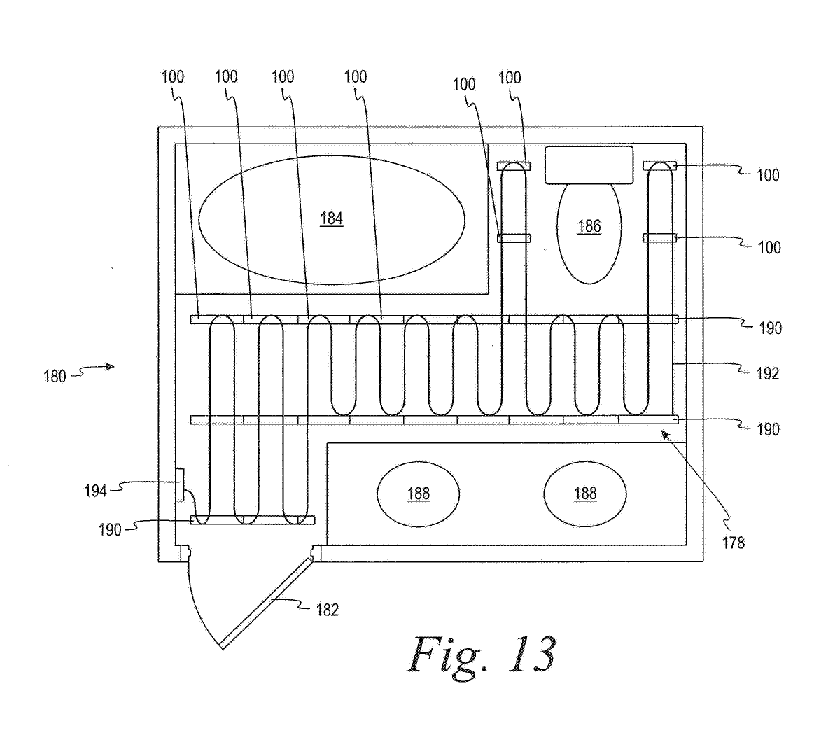

In some applications, multiple wire retaining apparatuses 100 may be connected together to form a wire retaining system 178 (see FIG. 13). FIGS. 7-9 depict detailed partial views of opposing ends of the wire retaining apparatuses 100, and the features used to connect multiple wire retaining apparatuses 100 together. Turning to FIGS. 7 and 8, one retention member 162 of the plurality of retention members 112 is only partially disposed on the base 102 and extends past the edge of the first end 104 of the base 102. The retention member 162 can include one or more rectilinear coupling apertures 164 extending through the flange portion 116 of the retention member 162. An upper protrusion 166 is disposed on the upper surface 126 proximate to the one or more coupling apertures 164. In the embodiment depicted, two coupling apertures 164 extend through the flange portion 116 and are disposed on opposing sides of the interior volume 130 of the wall portion 114. The retention member 162 also includes a lower protrusion 168 extending from an underside of the wall portion 114 (see FIG. 8).

As shown in FIG. 9, the second end 106 of the base 102 can include one or more coupling posts 170 extending upwardly therefrom. The coupling posts 170 may include a distal hook end 172 (see FIG. 10) designed to facilitate the attachment of one wire retaining apparatus 100 to another wire retaining apparatus 100, as described more below. The second end 106 of the base 102 may also include a circular through hole 142 extending through the base 102 and an opening 174 disposed adjacent the through hole 142. The opening 174 is preferable dimensioned to match the lower protrusion 168 such that the lower protrusion 168 may be inserted into the opening 174 when the wire retaining apparatuses 100 are being coupled together.

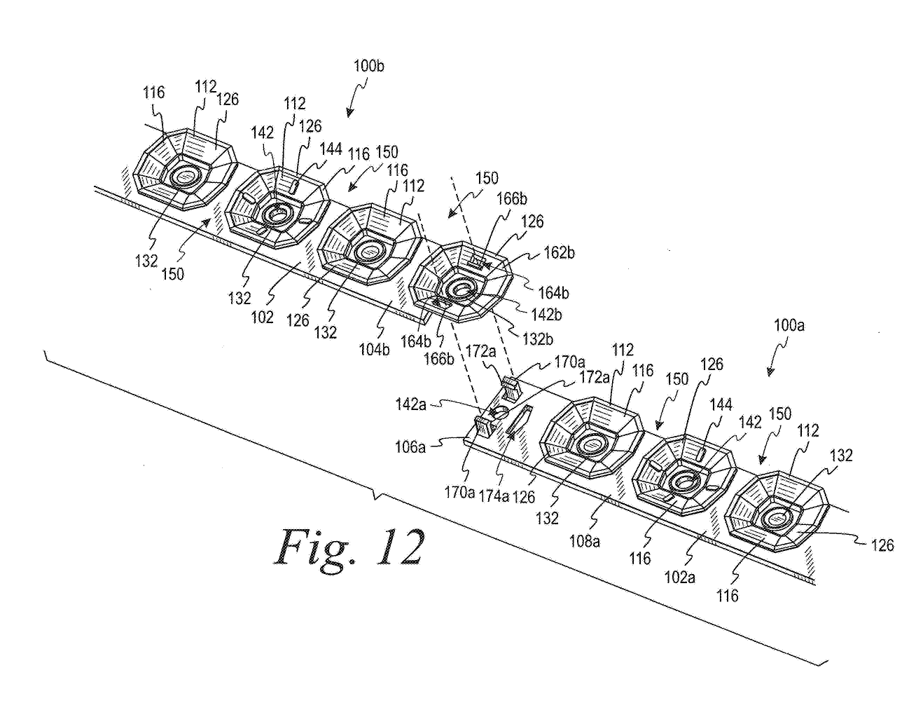

As shown in FIGS. 12 and 13, to form the wire retaining system 178, a plurality of the wire retaining apparatuses 100 may be connected together in some installations. To that purpose, the opening 174a is sized and positioned in the second end 106a of the base 102a of a first wire retaining apparatus 100a to receive the lower protrusion 168 (see FIG. 8) of a retention member 162b of a second wire retaining apparatus 100b. Also, the coupling posts 170a are sized and positioned on the upper face 108a of the base 102a at the second end 106a of the first wire retaining apparatus 100a to be received by the coupling apertures 164b of the retention member 162b of the second wire retaining apparatus 100b. The distal hook ends 172a of the coupling posts 170a are configured to snap into place over the upper protrusions 166b when the coupling posts 170a are inserted into the coupling apertures 164b.

A method of connecting a plurality of wire retaining apparatuses 100 is also contemplated. A plurality of wire retaining apparatuses 100 may be used in some applications necessitating the connection of a plurality of the wire retaining apparatus 100 into long straps 190 (See FIG. 13) in the form of the wire retaining system 178. The first end 104b of a first wire retaining apparatus 100b is aligned over the second end 106a of a second wire retaining apparatus 100a such that the coupling posts 170a are aligned with and positioned to be inserted into the coupling apertures 164b, and the lower protrusion 168 is positioned to be inserted into the opening 174b. The first end 104b of the first wire retaining apparatus 100b is pressed onto the second end 106a of the second wire retaining apparatus 100a until the coupling posts 170a are retained within and engage the coupling apertures 164b and the lower protrusion 168 is securely within the opening 174a. The installer knows the coupling posts 170a are fully inserted into the coupling apertures 164b when the distal hook ends 172a snap into place over the upper protrusions 166b. In some embodiments, an audible snap may be heard when the distal hook ends 172b snap into place. The process may be repeated for any number of wire retaining apparatuses 100 as required for a specific application.

It is contemplated that disconnecting of the wire retaining apparatus 100 may be necessary in some instances. To do so, the first wire retaining apparatus 100a may be twisted with respect to the second wire retaining apparatus 100b until the components are disengaged from each other. A small amount of deflection of the wire retaining apparatus 100 may be required for the disconnection.

It is also contemplated that the wire retaining apparatus 100 as describe above may be reinforced when installed. The through hole 142b located within the attachment guide 132b of the retention member 162b aligns with the through hole 142a located in the second end 106a of the base 102a when the first wire retaining apparatus 100b is joined with the second wire retaining apparatus 100a. When installed, the attachment mechanism used in the installation (e.g., a nail) can be driven through the aligned through holes 142a, 142b to secured the wire retaining apparatuses 100a, 100b together and to the surface the system 178 is being mounted on (not shown).

It is contemplated that the wire retaining apparatus 100 may be constructed out of a variety of materials depending on the requirements of an application. Polymers may be used to provide flexibility and inexpensive manufacturing costs in some embodiments. Some non-limiting examples of materials that may be used for the wire retaining apparatus 100 are polypropylene and polyethylene. It is contemplated that different materials with different properties may impact the ease of trimming a wire retaining apparatus 100 to a specific length. Further, the force required to insert a wire into the wire retaining apparatus 100 may be controlled by adjusting the properties of the materials. Other embodiments of the wire retaining apparatus 100 may be constructed from metals or composite materials. It is contemplated that wire retaining apparatuses 100 may be used in applications having harsh environmental conditions that may require numerous types of materials.

Now turning to FIG. 13, a schematic representation of an exemplary embodiment of an installation of a wire retaining system 178 in a room 180 (e.g., a lavatory) is depicted. The room 180 includes a door 182, a bathtub 184, a toilet 186, and two sinks 188. In the present application, the wire retaining apparatus 100 can be used to secure under floor heating wires. Straps 190 are formed by joining a plurality of the wire retaining apparatuses 100 as described above. (For clarity, the wire retaining apparatuses 100 forming the straps 190 in FIG. 13 do not show the retention members 112 and associated features.) As can be seen in the present embodiment, straps 190 of different lengths can be formed to provide an array that covers the floor space to be heated. Also, custom length straps 190 may be created by cutting one apparatus 100 and connecting a portion of the cut apparatus 100 to the strap 190. Further, one or more single wire retaining apparatuses 100 may form sections of the wire retaining system 178 and may be cut to shorter lengths as necessary. The straps 190 can be secured to a subfloor (not shown) and one or more wires may be retained in the manner described herein.

The working distance between the straps may vary depending on the specific application and/or the floor plan of the room. In some embodiments, the working distances may vary for different areas of the same room. The working distance may be from a few centimeters to a few meters, for example. In some embodiments, the working distance is about 90 centimeters for most of the straps 190. The wire retaining system 178 may include single wire retaining apparatuses 100 that are secured individually that have a working distance larger or smaller than the rest of the wire retaining system 178. Further, in some embodiments, it may be necessary to place straps 190 in different orientations relative to each other so that the majority of the floor is heated. For example, straps 190 may be secured parallel, perpendicular, and/or any other orientation in between relative to each other to insure proper coverage of heating wires. After the straps 190 are secured, one or more heating wires 192 are inserted into the wire insertion gaps (not shown) and secured in the wire retaining pockets (not shown) so that the wires are spaced to cover a significant amount of the floor. Next, the straps 190 and wires 192 are covered by various flooring applications known to one having ordinary skill in the art and the installation of the under floor heating system is complete. In some embodiments, the wire retaining system 178 and wire 192 may be covered with a self-leveling floor compound, mortar, or thin-set and cured before a final flooring is added. In certain embodiments, the wire retaining system 178 and wire 192 may be covered by mortar, or thin-set as a final layer of flooring is applied. It is contemplated that the wire retaining system and/or wires may be in communication with a controller 194 that facilitates operation thereof. In one specific embodiment, the controller is a thermostat.

It is also contemplated that the wire retaining apparatus 100 may be different shapes. For example, an L-shaped wire retaining system (not shown) may be beneficial in the application described above for placing wire around corners. In some embodiments, the shape of the wire retaining system may be any geometric shape that can be advantageously used in a specific application.

It is also contemplated that the wire retaining apparatus 100 may be utilized for retaining different types of wires. Further, any type of device that may be used to transmit a signal, electrical power, or utilized for heating can be retained. In some embodiments, the wire 192 may be in the form of a multi-conductor cable such that a complete circuit is formed with the controller 194 with a single connection. The wire retaining apparatus 100 may also be utilized for retaining communications cables such as ethernet cables or coaxial cables in some embodiments. It is further contemplated that wire retaining apparatus 100 may be utilized for retaining any type of cables for computers or electronic equipment in some embodiments.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A wire retaining apparatus, comprising:
a base having a first end and a second end opposite the first end and further including an upper side and a lower side; and
a plurality of retention members extending upwardly from the base, each retention member including a wall portion and a flange portion that circumscribes and protrudes from an upper peripheral portion of the wall portion,
wherein the flange portion is angled upwardly away from the upper side of the base forming a retention gap to securely retain at least two wires having a different diameter with respect to each other.

2. The wire retaining apparatus of claim 1, wherein one of the plurality of retention members extends at least partially past the edge of the first end of the base, and wherein the one retention member includes at least one of a lower protrusion or a coupling aperture.

3. The wire retaining apparatus of claim 2, wherein the second end of the base includes at least one of a coupling post or an opening.

4. The wire retaining apparatus of claim 1, wherein the base includes at least nine retention members extending therefrom.

5. The wire retaining apparatus of claim 1, wherein the wall portion of at least one of the plurality of retention members defines a volume and an attachment guide is disposed within the volume.

6. The wire retaining apparatus of claim 5, wherein one or more of the attachment guides includes a through hole in the base designed to receive a securing mechanism.

7. The wire retaining apparatus of claim 6, wherein any of the retention members that have an attachment guide including through holes further include at least one indicator protrusion disposed on the flange portion.

8. A wire retaining apparatus, comprising:
an elongate base having an upper side and a lower side; and
a plurality of retention members extending from the upper side of the base, each retention member including a wall portion and a flange portion that protrudes from the wall portion,
wherein the flange portions of each of the plurality of retention members form wire insertion gaps, and wherein the wire insertion gaps each have a variable gap width.

9. The wire retaining apparatus of claim 8, wherein the variable gap width is at its widest at an area adjacent an outer edge of the base.

10. The wire retaining apparatus of claim 9, wherein the variable gap width is at its shortest at an area defined by the closest point of two flange portions of adjacent retention members.

11. The wire retaining apparatus of claim 10, wherein the flange portion is generally decagonal in shape.

12. The wire retaining apparatus of claim 11, wherein the flange portion includes a lower angled surface that is angled upwardly and terminates at a substantially flat upper surface.

13. The wire retaining apparatus of claim 12, wherein at least one retention member defines a wire retention pocket that is configured to secure a plurality of wires having different diameters.

14. The wire retaining apparatus of claim 13, wherein the wire retention pocket is defined by the upper surface of the base, an outer surface of the wall portion, and a lower surface of the flange portion of the retention member.

15. The wire retaining apparatus of claim 14, wherein wires of different diameters may be securely retained in the wire retention pocket by contacting both the upper surface of the base and the lower surface of the flange portion.

16. A method of forming a wire retaining system by coupling a plurality of wire retaining apparatuses, the method comprising:
providing a first wire retaining apparatus including a plurality of retention members that form retention gaps for retaining one or more wires of different diameter, wherein the first wire retaining apparatus further includes one of the plurality of retention members that extends beyond an edge of a first end, and the one retention member includes a lower protrusion and at least one coupling aperture;
providing a second wire retaining apparatus including a plurality of retention members that form retention gaps for retaining one or more wires of a different diameter, wherein the second wire retaining apparatus further includes at least one coupling post and an opening;
aligning the first end of the first wiring apparatus over the second end of the second wiring apparatus so that the at least one coupling aperture is positioned to receive the at least one coupling post and the opening is positioned to receive the lower protrusion; and
pressing the first end of the first wire retaining apparatus onto the second end of the second wire retaining apparatus so that the at least one coupling post is retained within the at least one coupling aperture and the lower protrusion is retained within the opening.

17. The method of claim 16, further comprising:
providing a plurality of wire retaining apparatuses that include nine retention members and are substantially the same as the first and the second wire retaining apparatuses.

18. The method of claim 17, further comprising:
forming a first wire retaining strap by repeatedly aligning and pressing first ends of one or more of the plurality of wire retaining apparatuses onto the second ends of one or more of the plurality of wire retaining apparatus until a first length is reached.

19. The method of claim 18, further comprising:
forming a second wire retaining strap by repeatedly aligning and pressing first ends of one or more of the plurality of wire retaining apparatuses onto the second ends of one or more of the plurality of wire retaining apparatuses until a second length is reached.

20. The method of claim 19, further comprising:
securing the first wire retaining strap to a flooring surface; and
securing the second wire retaining strap to the flooring surface generally parallel to and a working distance away from the first wire retaining strap.
